(19) United States
(12) Patent Application Publication
(10) Pub. No.: US 2016/0314400 A1
(43) Pub. Date: Oct. 27, 2016

(54) PREDICTION OF A CURTAILED CONSUMPTION OF FLUID

(71) Applicant: ELECTRICITE DE FRANCE, Paris (FR)

(72) Inventors: Philippe Charpentier, Mareil-Marly (FR); Isabelle Debost, Chaville (FR)

(21) Appl. No.: 15/103,757

(22) PCT Filed: Dec. 10, 2014
(86) PCT No.: PCT/FR2014/053258

§ 371 Date: Jun. 10, 2016

(30) Foreign Application Priority Data
Dec. 11, 2013 (FR) 13 62407

(51) Int. Cl. G06N 5/04; G06F 17/50; G06F 17/11; G06N 99/00

(52) U.S. Cl. CPC G06N 5/04; G06N 99/005; G06F 17/5009; G06F 17/11; G06F 2217/16

(57) ABSTRACT

A computing system for predicting a curtailed consumption of fluid comprising: a module for collecting consumption data comprising information relating to an actual consumption of fluid of a plurality of consumers during a learning phase, a processing circuit for aggregating the consumption data collected by groups as a function of at least one determined descriptive variable associated with each consumer and contained in the consumption data, a processor for determining on the basis of the aggregated consumption data a curve of global load for each group, a computer for computing a model of extraction of a load curve, termed heating and/or air conditioning, on the basis of each global load curve and of meteorological data, and a predictor for computing a prediction of a curtailed consumption of fluid for each group during a forthcoming curtailment phase.

### TECHNICAL FIELD

The subject matter of the present invention concerns the field of the management of the consumption of fluid and relates more particularly to reduction of the consumption of fluid.

One of the objectives of the present invention is to predict accurately at a particular time the curtailed quantity of fluid for a future curtailment phase.

The present invention therefore finds numerous applications that are notably advantageous for energy operators by enabling them to manage in an optimized manner their production of fluid and to ensure a balance between fluid supply and demand, notably at the time of consumption peaks.

The present invention also finds other applications that are notably advantageous for adjustment operators by enabling them to quantify accurately the curtailed consumption of fluid during a curtailment period, for example in order to contractualize a curtailment offer.

By fluid in the context of the present invention there must be understood here and throughout the present description any energy source such as for example electricity, water, or gas or diesel that can be consumed by an equipment of a (domestic or industrial) installation, notably with a view to its operation.

### PRIOR ART

Metering the consumption of fluids has become a daily and growing challenge, as much for private persons as for industries: the reasons that encourage controlling this consumption are both economic (high financial costs) and ecological (pollution, greenhouse gas emission, management of natural resources).

To control this consumption energy operators have for several years been applying powerful energy policies aiming to reduce the consumption of fluid, notably during consumption peak periods.

For private persons, this consumption peak usually occurs in winter between 18:00 and 20:00; this is notably explained by climatic conditions at this time of year and standard domestic usages.

This consumption peak notably originates from the consumption of fluid for heating and/or for air conditioning. It is primarily a question of consumption of electrical energy.

In winter, when temperatures are lowest, these consumption peaks can exceed 100 gigawatts, as in France in February 2012, for example.

As electricity cannot be stored, it is necessary to ensure that electricity consumption is equal to production at all times; this balancing is weakened when demand is high.

An energy fluid consumption peak is generally addressed using by “fast” production means that are often polluting: for example turbines relying on combustion are used for the production of electrical energy.

In the field of electrical energy, it has been known for several decades to institute tariffs that encourage reduced energy consumption during consumption peaks.

To ensure the balance between the production and consumption of fluid, rather than continuing to construct evermore electric power stations and investing in the network, electric energy suppliers are now seeking to limit consumption by encouraging customers to consume less in certain periods.

Most electric energy suppliers have therefore instituted specific tariffs for so-called “slack” times and so-called “busy” times: the price of electricity is therefore increased over a particular time period in order to reduce or to shift demand.

Other solutions are also instituted for better control of this consumption and to ensure a balance between production and consumption; energy operators have therefore developed an enhanced policy in the form of Active Demand Management (ADM); this form of management aims to control and to reduce energy fluid consumption. This form of management operates both in the domestic market and in the industrial market.

One of the solutions consists in directly controlling the electrical load of some equipment.

For example, some electric usages such as heating can be intentionally interrupted at times of high demand, for example for two hours (preferably between 18:00 and 20:00).

During these times of reduced electricity consumption, the customer is referred to as “curtailed”, the customer having subscribed to this kind of curtailment service (often then benefiting from preferential tariffs).

These load control means are generally activated for only a few days a year (15 to 20 days), during the winter.

This makes it possible to reduce significantly the consumption of fluid and the final bill to the consumer.

It has now become decisive and strategically important to be able to predict accurately this curtailed fluid quantity, also known as “curtailment”; this curtailed fluid quantity corresponds here to the difference between the quantity of fluid actually consumed and the quantity of fluid that would have been consumed if the customer had not been curtailed (this theoretical quantity is also known as the “baseline”).

However, for these curtailments to be useful, the potential curtailable power must be known accurately.

If the curtailed power level is unknown or too inaccurate, additional production means have to be provided to take over from curtailment if necessary, which limits the benefit of curtailment.

For curtailment to be of real benefit and to offer good performance, it is necessary to be able to predict reliably the power that can be curtailed in the customer portfolio.

This prediction of the curtailed fluid quantity, or curtailment, is all the more strategic in that it is now possible to valorize this curtailment by reselling this energy, for example to an industry to operate their plant or to another energy operator (for example abroad): indeed their exist operators that undertake contractually to sell to another operator a quantity of unconsumed energy during a peak, for example every half-hour over a predetermined time interval.

This kind of practice enables an operator to face up to demand, which makes it possible to regulate the production of fluid.

Predicting this curtailed fluid consumption makes it possible to quantify a quantity of energy fluid with a view to indicating that quantity in a contract of sale, for example. Thus the operator can undertake in the contract to supply a quantity of energy fluid during a particular period.

It is clear that it is therefore crucial to be able to make such a prediction with great accuracy in order to comply with this contractual undertaking.

At a more local level, on a branch of the “low-tension” network, for example, it is possible to create groups of customers that can be curtailed as a function of the typology of the network.

Thus if the production means or the structures of the local networks are under-dimensioned to meet demand, it is possible to curtail the heating or the air conditioning of groups of customers agreeing to be curtailed to prevent load shredding across the entire region.

It is then possible to predict the power that can be curtailed in each group of customers that can be curtailed and, thanks to this prediction, only the number of customers necessary to ensure the production-consumption balance is curtailed.

Among other things this makes it possible to avoid always curtailment off the same customers.

This also makes it possible to preserve their comfort and consequently to maintain a good level of acceptability of the curtailment service.

Indeed, if the level of comfort of a customer drops too much, it will be difficult to continue to encourage them to be curtailed, and there is a risk of seeing many customers refuse curtailment.

Correctly predicting the power that can be curtailed therefore makes it possible to optimize the placement of the curtailments with customers in order to limit the reduction of the comfort of customers and to make curtailment more acceptable to them.

Although consumption curtailment is not new, it has become more complicated to implement.

In fact, with the emergence of new technologies and the remote control of heating and/or air conditioning usages, it has become more flexible.

An operator can therefore decide to curtail any number of customers in its portfolio at any time for a variable duration.

This considerably changes the “fixed” formats that are in place at present.

Moreover, customers are very often invited and encouraged to change tariffs.

The groups of customers participating in curtailment are therefore potentially modified from one season to another:
customers not subscribing to curtailment one season may go over to the service the next season;
customers can abruptly terminate their subscription to the curtailment service;
customers now readily change supplier or curtailment operator.

The prediction of the curtailment can therefore not be based only on a limited data history.

The groups of customers having been modified in terms of structure, their response to curtailment has also been modified.

Thus at the start of each season operators have groups of customers that can be curtailed without having seen the least curtailment in each of the groups.

Moreover, curtailments are useful around twenty times in winter and around ten times in summer.

Even if a group of customers is not modified from one season to another, a number of years are required to obtain a sufficient number of observations making it possible to estimate the parameters or the linking functions by conventional methods.

In fact, to estimate curtailment accurately at any time, on any day and under any climatic conditions, years of observations are generally required to develop models using conventional methods.

Teams linked to the operational control of the electric system, like the suppliers, distributors or curtailment operators therefore lack means to take curtailment into account in their load optimization and therefore tend to under-use the potential of new curtailment devices.

The document EP 2 047 577 concerns curtailment and proposes a solution for regulating energy consumption. It more particularly describes a method of management and of real time modulation of the electricity consumption of a set of consumers. In said document, to determine consumption in real time, the method provides for the installation of an electric control module on the premises of each consumer to send in “push” mode a periodic reading of consumption measurements to a central server that collects this information and establishes an individual estimate of consumption.

However, the applicant submits that nothing in the above document describes precisely the method used to produce a prediction of the curtailed consumption of fluid.

According to the applicant, at present there is no prior art method effective for the accurate prediction of the curtailed fluid consumption.

### SUMMARY AND OBJECT OF THE PRESENT INVENTION

The present invention aims to improve the situation described above.

The present invention therefore proposes a statistical approach for predicting effectively the curtailed fluid consumption for a future curtailment phase.

The subject matter of the present invention more particularly concerns a method of predicting a curtailed fluid consumption that is implemented by computer means; the prediction method includes firstly collecting consumption data.

The consumption data advantageously includes information relating to a real fluid consumption of a plurality of consumers during a learning phase.

Following this data collection, the method in accordance with the present invention includes aggregating the collected consumption data on a group basis. This aggregation on a group basis is preferably carried out notably as a function of one or more particular descriptive variables; these variables are associated with each consumer and are contained in the consumption data.

These descriptive variables are preferably selected from at least one of the following variables: the region, the accommodation type and area, the number of persons in the accommodation or the heating and/or air conditioning method.

Obviously, the person skilled in the art will understand here that other descriptive variables may equally well be envisaged in the context of the present invention.

The method in accordance with the present invention advantageously also includes determining a global load curve for each group from the aggregated consumption data. This global load curve is the curve relating to the consumption of fluid by each group during the learning phase.

The method in accordance with the present invention preferably includes calculating an extraction model of a load curve referred to as the heating and/or air conditioning load curve.

Here this heating and/or air conditioning load curve is the curve relating to the fluid consumption by each of the groups for heating and/or air conditioning.

This extraction model is preferably calculated from each global load curve and weather data; that weather data preferably contains information relating to the weather conditions for each group during the learning phase.

The method in accordance with the present invention advantageously includes predicting a curtailed fluid consumption for each group for a future curtailment phase.

In accordance with the present invention, this prediction is calculated as a function of each heating and/or air conditioning load curve estimated by the extraction model and a consumption data history.

Thanks to the succession of technical steps characteristic of the present invention, it is possible during a learning phase to construct an extraction model of a heating and/or air conditioning load curve from a global load curve to predict afterwards at a given time a curtailed fluid consumption for a future curtailment phase on the basis of a consumption data history.

Thus, according to results obtained by the applicant, the present invention makes it possible to predict accurately a curtailed fluid consumption across a set of consumers; this prediction enables predictive management of the energy production plan and/or selling this non-consumed energy on the adjustment market, for example.

The method in accordance with the present invention advantageously includes pre-processing before aggregating the consumption data.

During this pre-processing, the consumption data for at least one consumer is corrected if the consumption data of said at least one consumer is missing.

This correction makes it possible to have a consumption data sequence that is continuous over the learning phase, which makes it possible to minimize prediction errors.

This pre-correction may take numerous forms.

For example, if, for the same consumer, consumption data is missing over a period less than or equal to a predetermined threshold period, then the missing consumption data is estimated at the time of the correction by interpolation with other consumption data collected for that same consumer.

On the other hand, if, for the same consumer, consumption data is missing over a period greater than the predetermined threshold period, then the missing consumption data is estimated at the time of the correction by seeking in a consumption data history a consumption data sequence minimizing the distance from the collected consumption data.

These two complementary approaches to correcting the missing data are satisfactory: they minimize correction errors.

The particular threshold period is preferably three hours. Obviously, the person skilled in the art understands here that other periods may equally well be envisaged in the context of the present invention.

It is desirable for the aggregated global load curves obtained with the consumption data to be of good quality. To this end, the consumption data must be synchronized. Accordingly, in accordance with one advantageous variant, the fluid consumption data includes time information relating to the time at which the consumption of fluid by the consumer occurred. In accordance with this variant, the pre-processing advantageously includes synchronizing the data if it is not synchronized.

The consumption data is preferably synchronized by interpolation.

The weather data advantageously includes information relating to the outside temperature for each consumer during the learning phase.

In order for this weather data to be the most representative of the group, the method includes, for each group, calculating an average of the temperatures contained in the weather data weighted by the power demand of the consumers of the group.

Advantageously, the calculation of the extraction module includes modeling a power consumption demand for heating by the same group at a time t by LASSO type linear regression in accordance with the following formula:

$${\hat{β}}^{dh} ( τ ) = argmin ( {‖ {P}_{t} - {β}_{0}^{dh} - {\sum }_{h = 0}^{h = 23} ( {Tc}_{t - h} {β}_{h + 1}^{dh} - {Tn}_{t} {β}_{25}^{dh} ) ‖}^{2} + τ {‖ {\sum }_{i = 0}^{i = 25} {β}_{i}^{dh} ‖}_{1} )$$

in which:
the variable dh corresponds to the half-hour step in respect of which the aim is to model the power at the time t with dh iε[1,48];
Pₜ is the global power demand for a group at a time t;
β₀^{dh} is the constant associated with the model;
βₕ₊₁^{dh} correspond to the parameters associated with the temperature variables Tcₜ₋ₕ;
β₂₅^{dh} corresponds to the parameter associated with the normal temperature;
τ is a penalty constraint; and
\hat{β}_{dh}(τ) corresponds to the vector of the estimates of the parameters of the extraction model.

The temperature variables potentially being correlated with one another, the LASSO type algorithm can encounter a reduced efficacy in the estimation of the parameters of the model.

To improve the estimate, it is advantageous to replace the temperature variables by components, linear combinations of the temperature variables, that are mutually orthogonal.

The components are then constructed as a function of their links with the variable to be explained (for example here the power demand at the time t).

A PLS type algorithm is used for this, notably to recover the coordinates of the components.

In this case, only the components resulting from the PLS regression are retained for estimating the parameters of the model using LASSO regression.

The prediction of the curtailed fluid consumption at a time t for a prediction horizon k is advantageously estimated in accordance with the following formula:

\hat{\hat{P}}cₜ₊ₖ=Xₜ\hat{Ω}^{dh}

in which:
Xₜ represents a matrix of explanatory variables of the prediction model; and
\hat{Ω}^{dh}(τ) corresponds to the vector of the estimates of the parameters of the prediction model.

The method advantageously further includes a step of orthogonalization of the matrix Xₜ of the explanatory variables of the prediction module using a PLS1 type algorithm to maximize the correlation between the components of said matrix Xₜ and the parameters of the prediction model.

It is still possible to optimize the method and to reduce the costs thereof.

To this end, before the collection of consumption data, the method includes stratification of the consumers during which the inter-stratum variance is maximized and the intra-stratum variance is minimized.

This stratification is preferably effected notably on the basis of the above descriptive variables.

This stratification makes it possible to avoid installing metering devices on the premises of each of the consumers.

In a correlative way, the subject matter of the present invention relates to a computer program that includes instructions adapted to execute the steps of the method as described above, notably when said computer program is executed by a computer or at least a processor.

Such a computer program may utilize any programming language and take the form of source code, object code or an intermediate code between source code and object code, such as a partially compiled form, or any other desirable form.

Similarly, the subject matter of the present invention relates to a computer-readable or processor-readable storage medium on which is stored a computer program including instructions for executing the steps of the method as described above.

On the one hand, the storage medium may be any entity or device capable of storing the program. For example, the medium may include storage means such as a ROM, for example a CD-ROM or a solid state ROM, or magnetic storage means, for example a “floppy disk” type diskette or a hard disk.

On the other hand, this storage medium may equally be a transmissible medium such as an electric or optical signal, such a signal being routable via an electrical or optical cable, by conventional or microwave radio or by auto-directed laser beam or by other means. The computer program in accordance with the invention may in particular be downloaded over an Internet type network.

Alternatively, the storage medium may be an integrated circuit into which the computer program is incorporated, the integrated circuit being adapted to execute or to be used in the execution of the method in question.

The subject matter of the invention also relates to a computer system for predicting a curtailed fluid consumption.

The computer system more specifically includes:
a collecting module configured to collect consumption data including information relating to a real fluid consumption by a plurality of consumers during a learning phase,
a processing circuit configured to aggregate the collected consumption data on a group basis as a function of at least one particular descriptive variable associated with each consumer and contained in the consumption data,
a processor configured to determine from the aggregated consumption data a global load curve for each group,
a counter configured to calculate an extraction model from a so-called heating and/or air conditioning load curve relating to the global fluid consumption for heating and/or air conditioning of each of the groups from each global load curve and weather data containing at least information relating to the weather conditions for each group during said learning phase, and
a predictor configured to calculate a curtailed fluid consumption for each group for a future curtailment phase as a function of each heating and/or air conditioning load curve estimated by the extraction model and a consumption data history.

The computer system in accordance with the present invention advantageously also includes computer means that are specifically configured to execute the steps of the method as described above.

Thus, by virtue of its various functional and structural aspects described above, the present invention makes it possible to predict accurately the curtailed quantity of fluid consumption during a curtailment phase.

The present invention has the advantage of reliably predicting the power that can be curtailed without needing to observe the least curtailment.

### BRIEF DESCRIPTION OF THE APPENDED FIGURES

Other features and advantages of the present invention will emerge from the following description with reference to the appended FIGS. 1 to 5 that show one nonlimiting embodiment and in which:

FIG. 1 represents a diagrammatic view of a computer system conforming to one embodiment of the present invention;

FIG. 2 represents a graph illustrating the evolution of the power consumed as a function of the outside temperature;

FIG. 3 represents a graph illustrating the evolution as a function of time of the temperature, a heating and/or air conditioning curve and a global load curve;

FIG. 4 represents a graph illustrating the comparison between the real curtailed power and the prediction of a curtailed power; and

FIG. 5 represents a flowchart illustrating the remote learning method in accordance with one advantageous embodiment of the present invention.

### DETAILED DESCRIPTION OF ONE EMBODIMENT OF THE INVENTION

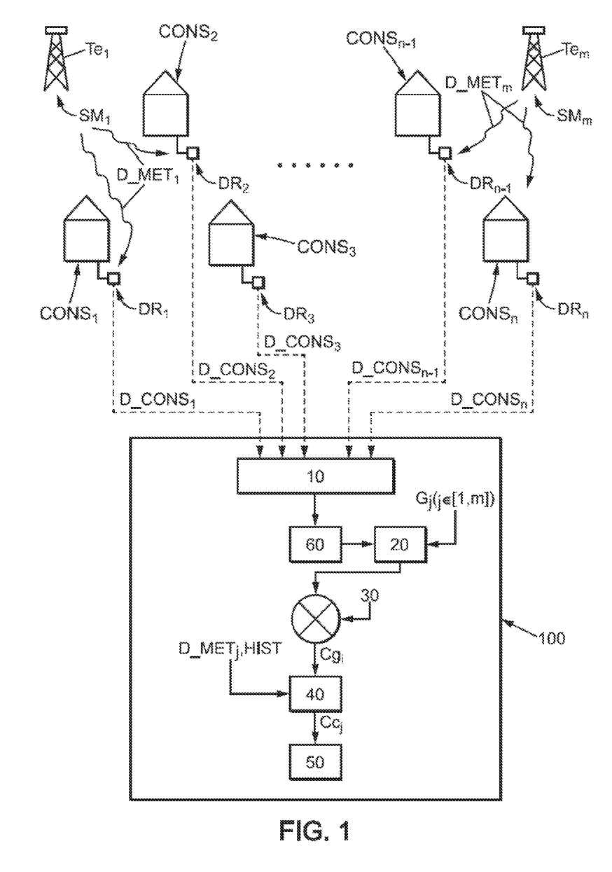

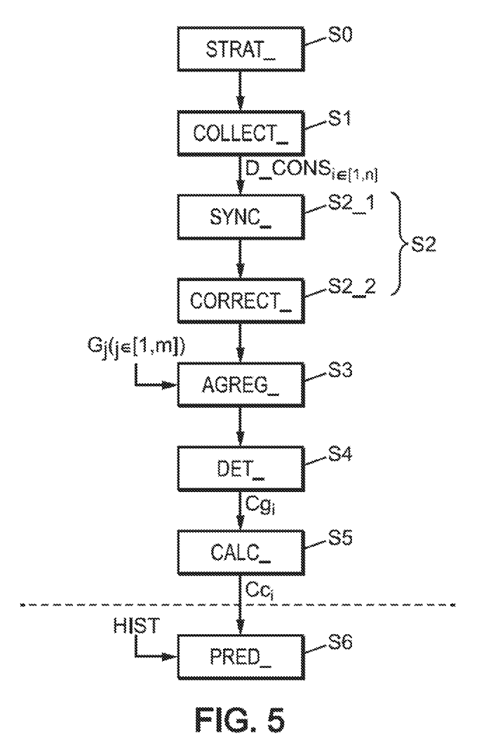

A method of predicting a curtailed fluid consumption, in accordance with one advantageous embodiment, and the associated computer system will now be described hereinafter with reference to FIGS. 1 to 5.

The curtailment mechanism has already been described hereinabove.

It was notably pointed out that in order for a curtailed power to be taken into account in the production plan of an energy operator or sold on the adjustment market it is desirable for this curtailment to be as accurate as possible, this curtailment corresponding to an unconsumed quantity of energy fluid.

In the residential sector, the greatest uptake of curtailment concerns electric heating and/or air conditioning; the example described here therefore relates to the electricity consumption linked to the operation of one or more electric heaters in a home, also referred to as the consumer. The person skilled in the art will understand here that the application of the present invention to other fluids and/or other types of consumption may be envisaged.

As the customers' heating and/or air conditioning are controlled on an ON/OFF basis, in order to predict the curtailment it is necessary to take into consideration the history of the curtailed usage load curve (heating and/or air conditioning).

Conventionally, to predict this curtailment, it is necessary to collect the heating and/or air conditioning curve of each customer, to process and then to aggregate all of these curves, and finally to predict the heating and/or air conditioning power demand at a particular horizon in order to determine the curtailment potential at that horizon.

This approach is costly.

In fact it necessitates instrumentation of the electric heating and air conditioning system of each home, which implies the deployment of dedicated hardware and the intervention of a specialist electrician.

Moreover, this approach necessitates a highly sophisticated computer system to process all of the data acquisition subsystem within a reasonable delay.

In other words, predicting this curtailment is costly.

The present invention remedies these problems and proposes a powerful alternative solution that makes possible a saving in terms of hardware, installation costs and computer costs.

One of the objectives of the present invention is to reduce the average cost of the solution per customer.

In the example described here, and as shown in FIG. 1, the computer system 100 in accordance with the present invention therefore includes a collection module 10 that is configured to collect consumption data D_CONSᵢ, iε[1,n] in a collection step S1 that is sent by the meter reading devices DR₁, . . . , DRₙ associated with each electric meter installed in the home of each consumer CONSᵢ, iε[1,n].

In the example described here, this data D_CONSᵢ, iε[1,n] notably includes information relating to the real consumption of electricity of a plurality of consumers CONSᵢ, iε[1,n] during a learning phase J.

In the example described here, this data also includes time information relating to the time at which the consumption of electricity by the consumer occurred. This is referred to as time and date stamping.

In the example described here, this collection step S1 is carried out with a collection increment of 30 minutes, i.e. a half-hour increment. Obviously, the person skilled in the art will understand here that it is possible to collect data with a different collection increment, for example an increment of 20, 15 or 10 minutes.

The increment of 30 minutes makes it possible to obtain results of good quality, this increment corresponding to the official increment of the adjustment mechanism.

Following this collection step S1, the consumption data may undergo pre-processing in a step S2 to enhance its subsequent exploitation.

In the example described here, this pre-processing includes a step S2_1 of synchronizing the consumption data D_CONSᵢ if the latter is not synchronized.

In the example described here, it is in fact desirable for the consumption data D_CONSᵢ to be synchronized and preferably to arrive every 30 minutes starting at midnight.

In the example described here, if the consumption data D_CONSᵢ is less than one minute out of synchronization, only the time and date stamping of that data is modified.

For example, consumption data D_CONSᵢ for a consumer i that has a time and date stamp corresponding to “00h10m30s” is reset to “00h10m00s” after synchronization.

If on the other hand the consumption data D_CONSᵢ is out of synchronization by more than one minute, then the data is interpolated to reset the time and date stamping.

In the example described here, once synchronized, the data can be corrected if necessary. Thus the pre-processing further includes a data correction step S2_2.

To be more specific, if consumption data D_CONSᵢ for at least one consumer CONSᵢ is missing then that data is corrected or rather added to.

In the example described here, if consumption data D_CONSᵢ for the same consumer CONSᵢ is missing over a period less than or equal to a threshold period equal to three hours, for example, then the missing consumption data is estimated by interpolation with other consumption data collected for the same consumer.

In other words, if a missing data sequence is of less than three hours duration, then the missing consumption data is interpolated with other consumption data that has been collected.

In the example described here, if the missing data sequence is of more than three hours duration, on the other hand, then the missing consumption data is estimated by seeking in a consumption data history a data sequence minimizing the distance with the consumption data that has been collected.

In other words, in the example described here, if this missing data sequence is of greater than 3 hours duration (and less than 24 hours), a form copy is produced.

The data series is converted into a power curve. The curve is then divided into days.

In this example, if the original curve comprises 200 days, then the result is 200 curves. To correct the sequence missing from a daily curve, days with no missing values are searched for the curve whose distance is minimal over the non-missing time increments with the curve including a missing sequence.

The powers of the selected curve are copied over onto the missing points resynchronized to the energy of the non-missing points.

Thanks to the various pre-processing operations carried out by a pre-processing circuit 60 configured for this purpose, a complete consumption data sequence is therefore available.

Once this pre-processing has been done, the consumption data D_CONSᵢ is aggregated on a group basis, Gⱼ, jε[1,m]. Here the example is taken of m groups, where m is strictly less than or equal to n.

This aggregation step S3 is carried out by a processing circuit 20 as a function of a plurality of particular descriptive variables associated with each consumer CONSᵢ. This variable may be initially contained in the consumption data D_CONSᵢ.

In the example described here, these descriptive variables include information relating to the region, for example, the type of accommodation, the heating and/or air conditioning means, the number of persons per accommodation, etc.

These descriptive variables may equally be recovered during previous sampling and stored in a database of the system 100 (not shown here).

The person skilled in the art will therefore understand here that this aggregation of the consumption data is carried out according to how the operator wishes to manage its portfolio of clients.

Following this aggregation step S3, during a determination step S4 the average global load curve Cgⱼ for each group G is calculated from the consumption data relating to the consumers belonging to said group. To each group G there therefore corresponds a mean global load curve Cgⱼ.

It is possible for the consumption data to be skewed, notably if the learning period includes one or more curtailment periods, for example.

In this case, the past curtailments and the associated load reports (also known as “rebounds”) can skew the history of the global load curve. This can modify the extracted heating load curve and degrade the forecast of the curtailable power potential.

It may therefore be necessary to correct the skew of the variables resulting from the curtailment and the load transfer. To this end it is optionally possible to estimate the “baseline” during the curtailment and up to three hours after the curtailment.

This is notably possible using the estimation method described in the applicant's patent application FR 13 54694.

Thanks to the application of this estimation method, the skewed powers of the data history will therefore be replaced by those from the “baseline”.

Thereafter, in the example described here, weather data D_METⱼ is recovered, for example via the collection module 10 or by other means. This data contains information relating to the weather conditions for each group Gⱼ during said learning phase J.

To be more specific, in accordance with a variant, this weather data is recovered directly from weather stations SM₁ to SMⱼ by the meter reading devices DR₁ to DRₙ.

In the example described here and shown in FIG. 1, the meter reading devices DR₁, DR₂ and DR₃ associated with the consumers CONS₁, CONS₂ and CONS₃, respectively, recover from the weather station SM₁ the weather data D_MET₁ containing information such as the outside temperature Te₁, for example. In the same way, in the example described here, the meter reading devices DRₙ₋₁ and DRₙ associated with the consumers CONSₙ₋₁ and CONSₙ, respectively, recover from the weather station SMₘ the weather data D_METₘ containing information such as the outside temperature Teₘ, for example.

This is obviously merely one of a number of examples.

Alternatively, this data from weather stations SM₁ to SMₘ associated with each consumer or each group of consumers can be recovered directly by the collection module 10. In this case, the weather stations are geolocated just like the consumers; to establish the association between the consumer and the weather data, the available weather station nearest a consumer is therefore looked for.

For each group, an average of the curves from the weather stations weighted by the power demand of the customers belonging to the group is calculated in order for the weather data to be representative of the group.

A global load curve Cgⱼ for each group G is then determined by a processor 30 of the system 100 during a determination step S4.

This global load curve Cgⱼ represents the electricity consumption of each group Gⱼ during the learning phase.

In the example described here, the present invention seeks to extract the so-called heating and/or air conditioning load curve Ccj relating to the electricity consumption for heating of each of the groups Gⱼ from each global load curve Cgⱼ and the weather data D_METⱼ; here j is a positive integer between l and m inclusive.

This extraction requires the best possible modeling of the impact of temperature on the instantaneous level of the global load curve. This modeling is effected by a computer 40 during a calculation step S5 in which an extraction model is calculated.

To extract this heating and/or air conditioning load curve properly, the following functioning has been observed:

The variation of the load curve linked to heating and/or air conditioning depends on the outside temperature. However, the thermal inertia of buildings means that it is not the instantaneous raw outside temperature that impacts on the level of the load curve, but rather all past outside temperatures.

In fact, an outside temperature at a particular time “enters” the building with a certain time lapse.

Moreover, once it has entered, this outside temperature impacts on the load curve for a certain time; the impact of the outside temperature on this curve then progressively decreases.

The applicant has also observed that there is a significant link between the outside temperature and the power demand. This link is linear if the temperature is below a threshold temperature. For the heating example, if the outside temperature is high then consumers do not use their heating much or at all and the outside temperature no longer impacts the global load curve.

The heating power demand is therefore a linear combination of the past temperatures if the latter are below the threshold temperature Ts.

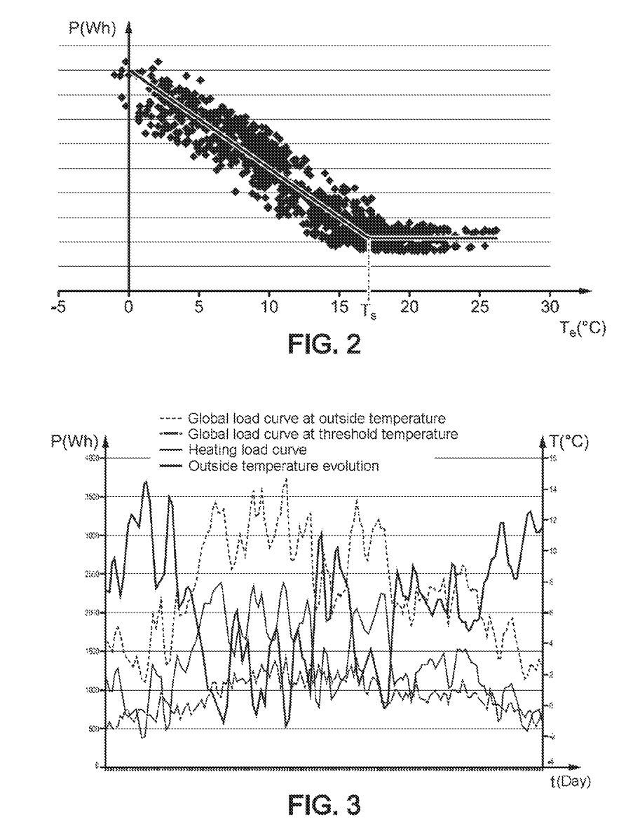

FIG. 2 illustrates this phenomenon.

Moreover, consumers likewise do not use their heating or their air conditioning over time: for example, some consumers do not use their heating or their air conditioning when they are away or sleeping.

Moreover, external inputs (such as sunshine) differ according to the time of day.

Consequently, what is required is to have a model by time increment and by day.

If the load curve is measured every half-hour it is then necessary to construct 48 extraction models: one model for each time increment.

It has moreover been noted that some usages do not depend on temperature, such as lighting, but nevertheless correlate with the outside temperature.

To prevent them from being taking into account in extracting the heating and/or air conditioning curve, the normal temperature variable has to be introduced in order to model so-called “seasonal” usages.

Moreover, to reflect the thermal inertia of buildings, smoothed temperatures are used instead of raw temperatures.

Now, if the portfolio of consumers fluctuates in terms of its perimeter or if some consumers have work undertaken in their house, temperature smoothing is no longer appropriate.

The present invention therefore provides automatic adaptation of perimeter changes.

Here the underlying concept consists in estimating the impact of each hourly temperature over the previous 48 hours on the power demand of the accommodation at a particular time if those temperatures are below the heating and/or air conditioning threshold temperature.

The delayed temperatures being numerous and strongly correlated with one another, the extraction model is based on a so-called LASSO criterion.

The advantage of LASSO regression is to be able to take into account in the model numerous variables with a certain correlation between them, which is not possible with a standard linear regression (the estimation of the parameters becomes unstable).

Moreover, the selection of variables of a linear regression is a discrete process, i.e. the variable is either retained or eliminated. LASSO regression is a more continuous form of selection and makes it possible to retain more information.

In the example described here, it is therefore desirable to determine the threshold temperature mentioned above and shown in FIG. 2. That temperature is calculated for each time increment and for each temperature delay. The person skilled in the art will understand here that this threshold temperature is the temperature below which the electric heating or air conditioning is started up.

As shown in FIG. 2, the impact of the temperature on electric consumption is meaningful only below a certain temperature, namely this threshold temperature.

To detect this temperature for a delayed temperature variable, the present invention provides for regression of the power demand at a time t on the temperature in a degree 1 B-spline base with an interior node (corresponding to the threshold temperature).

In this example, the position of the node is caused to fluctuate and there is chosen as the optimum position of the node the position that minimizes the mean square error of the regression.

The function to be minimized is therefore the mean square error of the B-spline regression of the power demand on the temperature according to the position of the interior node of the B-spline base.

In the example described here, the Nelder-Mead method is used to optimize this function. The mathematical formalism for estimating this temperature is as follows:

$${t - h}_{} = {argmin \{ {‖ {P}_{t} - B ( {Tb}_{t - h} ) β ‖}^{2} \}}_{{Ts}_{t - h} , β}$$

where
Pₜ is the power demand at a time t,
Tsₜ₋ₕ is the threshold temperature at t-h optimizing the MSE of the regression between the power demand at the time t and the delayed raw temperature Tbₜ₋ₕ,
B(Tbₜ₋ₕ) is the raw temperature variable delayed by h hours in the B-spline base,
β is the parameter vector of the regression,
tε(0, T) is the index of the data history.

Once the threshold temperature has been found, the raw temperature variable is converted into a “thresholded” temperature according to whether what is wanted is to extract the heating load curve or the air conditioning load curve.

For heating, the conversion is as follows:

$${Tc}_{t - h} = \{ \begin{matrix}{Tb}_{t - h} - {t - h}_{} , & {Tb}_{t - h} < {t - h}_{} \\ 0 , & {Tb}_{t - h} \geq {t - h}_{}\end{matrix}$$

For air conditioning:

$${Tc}_{t - h} = \{ \begin{matrix}{Tb}_{t - h} - {t - h}_{} , & {Tb}_{t - h} < {t - h}_{} \\ 0 , & {Tb}_{t - h} \geq {t - h}_{}\end{matrix}$$

where Tcₜ₋ₕ is the temperature delayed by h hours linked to the “heating” or “air conditioning” power demand at a time t.

Accordingly, in the example described here, the computer system 100 includes a computer 40 that is configured to model, during a step S5, the power demand Pₜ at a time t using a LASSO regression taking account of the following variables:
the last 24 temperatures Tcₜ₋ₕ relative to the time t. hε[[0,23]]
Tnₜ the normal temperature at the time t.

As the reaction of the power demand to temperature differs from one half-hour to another, it is desirable to estimate a LASSO model per time increment in a day (i.e. 48 models and therefore 48 sets of parameters in the half-hour situation); the computer 40 in accordance with the present invention is therefore implemented so as to employ the following algorithm:

$${\hat{β}}^{dh} ( τ ) = argmin ( {‖ {P}_{t} - {β}_{0}^{dh} - {\sum }_{h = 0}^{h = 23} ( {Tc}_{t - h} {β}_{h + 1}^{dh} - {Tn}_{t} {β}_{25}^{dh} ) ‖}^{2} + τ {‖ {\sum }_{i = 0}^{i = 25} {β}_{i}^{dh} ‖}_{1} )$$

where
dh corresponds to the “typical half-hour” where the aim is to model the power thereof at the time t with dhε[[1,48]],
β₀^{dh} is the constant associated with the model,
βₕ₊₁^{dh} are the parameters associated with the temperature variables Tcₜ₋ₕ,
β₂₅^{dh} is the parameter associated with the normal temperature,
τ is the penalty constraint,
\hat{β}^{dh}(τ) is the vector of the estimates of the parameters of the model.

The temperature variables potentially being correlated with one another, the LASSO algorithm may encounter lower efficacy in the estimation of the parameters of the model.

To improve the estimate, in the example described here the temperature variables are replaced with mutually orthogonal components, linear combinations of the temperature variables.

The components are then constructed as a function of their link with the variable to be explained (here the power demand at the time t).

The PLS1 algorithm is used for this.

In this algorithm, only the coordinates of the components are recovered.

The coefficients of the PLS regression are of no interest, the parameters of our model being estimated by LASSO regression on the components obtained from the PLS regression.

The penalty constraint i is chosen by cross validation with K=10. Once this parameter has been fixed, the parameters of the model are estimated across all of the available data.

To extract the heating and/or air conditioning load curve with the half-hour increment, the model described above is applied retaining only the variables Tc_{t-i*p} and their associated parameters:

\hat{P}cₜ=Pₜ−\hat{β}₀^{dh}−β₂₅^{dh}Tnₜ

where
\hat{P}cₜ is an estimate of the heating power demand at the time t for the typical half-hour dh.

It is therefore possible to reconstitute the heating and/or air conditioning load curve Ccⱼ from the global load curve Cgⱼ (see FIG. 3).

Accordingly, thanks to this modeling, it is possible to calculate an estimate of the heating and/or air conditioning load curve Ccⱼ from consumption data and a weather data history HIST.

That history is used thereafter as a learning history to develop the curtailable power prediction model.

In the example described here the curtailable power load curve is the load curve Ccⱼ relating to heating and/or air conditioning since this is the only usage that is controlled.

Accordingly, predicting the curtailable power load curve amounts to predicting the heating and/or air conditioning power demand load curve.

Previously, the heating load curve Ccⱼ was extracted from the global load curve Cgⱼ.

In a correlated way, it is possible here to extract the heating and/or air conditioning load curve from the data history. This is made possible by a predictor 50 that is configured to calculate during a prediction step S6 a prediction of a curtailed electric consumption for a future curtailment.

Accordingly, in the example described here, the estimate of the heating and/or air conditioning load curve based on the data history is used as a learning history to establish a prediction model of the heating and/or air conditioning load curve.

In the example described here, the variables retained in this modeling are as follows:
The half-hour powers for the latest 48 half-hours available.
The half-hour power of the same typical half-hour seven days before.
The latest eight thresholded three-hour temperatures starting from the time that the aim is to predict.
The day of the week type indicators (Saturday, Sunday, Monday, . . . , public holidays).
The normal temperature at the time that the aim is to predict.

As previously for extracting the heating and/or air conditioning load curve, the reaction to temperature of the power demand differs from one half-hour to another. Consequently, the prediction depends on the typical half-hour of the time t+k that the aim is to predict.

It is therefore necessary to establish 48 prediction modules for a half-hour increment.

The mathematical formalism of the prediction model is as follows:

\hat{\hat{P}}c_{t÷k}=f^{dh}(\hat{P}cₜ, . . . P̅cₜ₋₄₇,\hat{P}ₜ₊ₖ₋₃₃₆,Tcₜ₊ₖ . . . ,Tcₜ₊ₖ₋₄₅,1_{{Monday}}, . . . ,1_{{Sunday}},Tnₜ₊ₖ)+ε

where
\hat{\hat{P}}cₜ₊ₖ is an estimate of the power to be predicted at t+k where t is the time at which the prediction is done and k is the prediction horizon,
f^{dh} is the function linking the variable to be predicted and the explanatory variables of the prediction module, with dh being the typical half-hour of the time t+k that the aim is to predict.

As mentioned above, there are several methods for solving this problem. LASSO modeling is selected; the predictor 50 is therefore configured to use the following mathematical argument:

\hat{Ω}^{dh}(τ)=arg min(∥\hat{P}cₜ₊ₖ−XₜΩ^{dh}∥²+τ∥Ω^{dh}∥₁)

where
dh corresponds to the “typical half-hour” for which the aim is to model the power at the time t with dhε[[1,48]],
\hat{P}cₜ₊ₖ is the curtailment uptake that the aim is to predict at the time t+k,
Xₜ represents the matrix of the explanatory variables of the prediction model in which each column corresponds to each of the variables previously listed above,
τ is the penalty constraint,
Ω^{dh} is the vector of the parameters of the model,
\hat{Ω}^{dh} is the vector of the estimates of the parameters of the model.

As pointed out above, the variables participating in the model being potentially correlated with one another, the LASSO algorithm can encounter less efficacy in estimating the parameters of the model. To improve the estimate, the original variables of the model could be replaced by mutually orthogonal components, linear combinations of the original variables. The components must be constructed as a function of their link with the variable to be explained (in our case the power to be predicted at the time t). The PLS1 algorithm will be used for this. From this algorithm, we recover only the coordinates of the components. The coefficients of the PLS regression will be of no interest, the estimation of the parameters of our model being obtained by LASSO regression of the variable to be predicted on the components originating from the PLS.

To estimate the parameters of the model, the penalty constraint r must be chosen. This penalty constraint is selected by cross validation with K=10. Once this parameter has been set, the parameters of the model are estimated across all of the available data.

Once the model has been estimated, the formula implemented by the predictor 50 to obtain the curtailable power predicted at a time t and at a horizon k is as follows:

\hat{\hat{P}}cₜ₊ₖ=Xₜ\hat{Ω}^{dh}

When it is the orthogonal components that have been injected into the model instead of the original variables, it must not be forgotten to project the coordinates Xₜ into the base of the components and to use these new coordinates to produce the prediction.

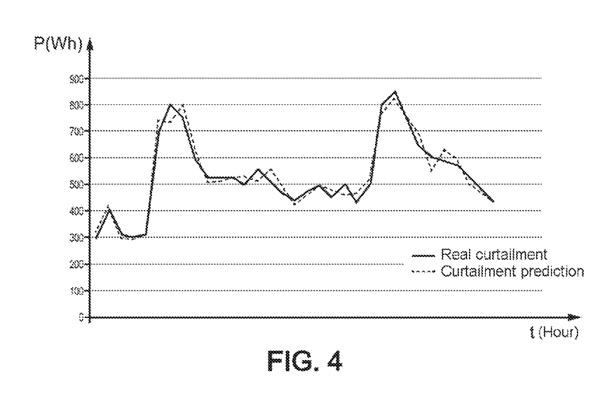

The comparative results shown in FIG. 4 are satisfactory; this figure shows in fact that the distance between the actual curtailment and the prediction of the curtailment obtained using the model is minimal and makes it possible to achieve good accuracy.

For some groups of customers, it is not possible to curtailed off all heating or air conditioning devices because:
the customer does not wish some of their devices to be controlled, such as the towel warmer in the bathroom; they wish to be able to retain control of the device,
the consumer unit does not enable good identification of the devices to be curtailed off,
some of the customers in the group cancel the curtailment instruction.

In this case, the heating or air conditioning load curve Ccj of the customers of the group j is higher than the curtailable load curve Cej for the customers of the group j, Ccj>Cej.

Consequently, the method described above tends to overestimate the curtailment that can be achieved for these customers.

This therefore gives rise to a problem of production-consumption balance on networks in which customers participating in curtailment are situated.

This is because, by overestimating the curtailment, we do not anticipate mobilizing sufficient production means to meet the demand.

To solve this problem, a final step is added to our method of predicting the curtailable power.

Once the first two curtailments have been done on a group, the prediction and the reality will be compared to correct the skew of the prediction.

To this end a regression will be applied between the predicted power \hat{P}cₜ₊ₖ and the curtailment estimated a posteriori using the selected “baseline” method.

In practical terms, the observed curtailed mean power [symbol] is calculated for each curtailment session (observed using the “baseline” method) that will be regressed on the predicted average (heating or air conditioning) power [symbol] for each curtailment session:

[symbol]

=\hat{α}+

[symbol]

Accordingly, to obtain the curtailable power prediction for each subsequent curtailment session, we determine the power that can really be curtailed from:

[symbol]

=\hat{α}+

[symbol]

This latter model will have to be updated after each curtailment session since we lack any starting of observation.

It is possible to improve the method described above and to make it even less costly by sampling. This refers to stratified sampling.

Accordingly, instead of going to the premises of all consumers to install a device enabling consumption data to be measured, the proposed solution is to employ sampling.

In the example described here, the meter reading devices are installed on the premises of only some consumers and not all the consumers from the curtailment portfolio.

For that portfolio, descriptive variables make it possible to explain the heating and/or air conditioning consumption and consequently the curtailment.

Accordingly, for each consumer, the energy operator holds information on the type of accommodation, the area of the accommodation, the year the accommodation was constructed, the weather station nearest the home of the customer, the regular presence of a person during the daytime, the number of persons living in the accommodation.

On the basis of these variables providing auxiliary information on the variable of interest (the heating and/or air conditioning power demand at a time t), the data is collected by stratified sampling.

The strata consists of so-called homogeneous consumers. In other words, the consumers of the same stratum must as homogeneous as possible.

The aim here is therefore to maximize the inter-strata variance and to minimize the intra-strata variance.

The greater the number of strata, the better the accuracy of the estimator.

In the example described here, the aim is to retain a reasonable number of strata in order to have at least two customers per stratum, which makes it possible to estimate accurately the dispersion within the stratum and in the end to calculate the accuracy of the variable of interest.

Once the strata have been defined by crossing modalities per variable, the consumption data in each stratum is collected by simple random sampling with no rebate.

This stratification step S0 makes it possible to reduce significantly the overall cost of the process.

For example, the present invention therefore makes it possible to integrate on the upstream side a curtailment uptake in order to integrate it into an energy production plan. This enables a supplier to predict in the short term the quantity of energy that can be curtailed across a set of clients (also referred to as the curtailment uptake).

As mentioned above, in the residential field, the curtailment uptake is explained by various explanatory variables that include lifestyle, type of accommodation, outside temperature.

That outside temperature is the most meaningful variable, notably in relation to the consumption of electricity for heating and/or air conditioning.

The present invention proposes a mathematical and statistical approach to take account of all these parameters and to be in a position to predict this uptake with good accuracy.

It should be pointed out that this detailed description relates to one particular embodiment of the present invention, and that in no way does this description have any kind of limiting character with regard to the subject matter of the invention; indeed, to the contrary, its objective is to eliminate any possible inaccuracy or misinterpretation of the following claims.

1. A method of predicting a curtailed fluid consumption, implemented by computer means, including the following steps:
collecting consumption data including information relating to a real fluid consumption of a plurality of consumers during a learning phase,
aggregating the collected consumption data on a group basis as a function of at least one particular descriptive variable associated with each consumer and contained in the consumption data,
determining from the aggregated consumption data a global load curve for each group relating to the fluid consumption of each group during the learning phase,
calculating an extraction model of a heating and/or air conditioning load curve relating to the fluid consumption for heating and/or air conditioning of each of the groups from each global load curve and weather data containing at least information relating to the weather conditions for each group during said learning phase, and
predicting a curtailed fluid consumption for each group for a future curtailment phase as a function of each heating and/or air conditioning load curve estimated by the extraction model and a consumption data history.

2. The method as claimed in claim 1 including, before aggregating the consumption data, pre-processing during which a correction of the consumption data for at least one consumer is carried out if consumption data for said at least one consumer is missing.

3. The method as claimed in claim 2, wherein, if, for the same consumer, consumption data is missing over a period less than or equal to a predetermined threshold period, then the missing consumption data is estimated, at the time of the correction, by interpolation with other consumption data collected for that same consumer.

4. The method as claimed in claim 2, wherein, if, for the same consumer, consumption data is missing over a period greater than a predetermined threshold period, then the missing consumption data is estimated, at the time of the correction, by seeking in a consumption data history a consumption data sequence minimizing the distance from the collected consumption data.

5. The method as claimed in claim 2, wherein the particular threshold period is three hours.

6. The method as claimed in claim 2, wherein the fluid consumption data includes time information relating to the time at which the consumption of fluid by the consumer occurred and wherein the pre-processing includes synchronizing said data if it is not synchronized.

7. The method as claimed in claim 6, wherein the synchronization of the consumption data is effected by interpolation.

8. The method as claimed in claim 1, wherein the weather data contains information relating to the outside temperature for each consumer during the learning phase and wherein there is calculated for each group an average of the temperatures contained in the weather data weighted by the power demand of the consumers of said group.

9. The method as claimed in claim 1, wherein said at least one descriptive variable is selected from at least one of the following variables: the region, the accommodation type and area, the number of persons in the accommodation or the heating and/or air conditioning method.

10. The method as claimed in claim 1, wherein the calculation of the extraction module includes modeling a power consumption demand for heating by the same group at a time t by LASSO type linear regression in accordance with the following formula:
$${\hat{β}}^{dh} ( τ ) = argmin ( {‖ {P}_{t} - {β}_{0}^{dh} - {\sum }_{h = 0}^{h = 23} ( {Tc}_{t - h} {β}_{h + 1}^{dh} - {Tn}_{t} {β}_{25}^{dh} ) ‖}^{2} + τ {‖ {\sum }_{i = 0}^{i = 25} {β}_{i}^{dh} ‖}_{1} )$$
in which:
the variable dh corresponds to the half-hour step of which the aim is to model the power at the time t with dh iε[1,48];
Pₜ is the global power demand for a group at a time t;
β₀^{dh} is the constant associated with the model;
βₕ₊₁^{dh} correspond to the parameters associated with the temperature variables Tcₜ₋ₕ;
β₂₅^{dh} corresponds to the parameter associated with the normal temperature;
τ is a penalty constraint; and
\hat{β}^{dh}(τ) corresponds to the vector of the estimates of the parameters of the extraction model.

11. The method as claimed in claim 10, wherein the prediction of the curtailed fluid consumption at a time t for a prediction horizon k is estimated in accordance with the following formula:
\hat{\hat{P}}=Xₜ\hat{Ω}^{dh}
in which:
Xₜ represents a matrix of explanatory variables of the prediction model; and
\hat{Ω}^{dh}(τ) corresponds to the vector of the estimates of the parameters of the prediction model.

12. The method as claimed in claim 10, including a step of orthogonalization of the matrix Xₜ of the explanatory variables of the prediction module using a PLS1 type algorithm to maximize the correlation between the components of said matrix Xₜ and the parameters of the prediction model.

13. The method as claimed in claim 1, including, before the collection of consumption data, stratification of the consumers during which the inter-stratum variance is maximized and the intra-stratum variance is minimized.

14. (canceled)

15. A computer-readable storage medium on which is stored a computer program including instructions for executing the steps of the method as claimed in claim 1.

16. A computer system for predicting a curtailed fluid consumption, including:
a collecting module configured to collect consumption data including information relating to a real fluid consumption by a plurality of consumers during a learning phase,
a processing circuit configured to aggregate the collected consumption data on a group basis as a function of at least one particular descriptive variable associated with each consumer and contained in the consumption data,
a processor configured to determine from the aggregated consumption data a global load curve for each group,
a computer configured to calculate an extraction model from a so-called heating or air conditioning load curve relating to the fluid consumption for heating and/or air conditioning of each of the groups from each global load curve and weather data containing at least information relating to the weather conditions for each group during said learning phase, and
a predictor configured to calculate a curtailed fluid consumption for each group for a future curtailment phase as a function of each heating and/or air conditioning load curve estimated by the extraction model and a consumption data history.

17. (canceled)
